(19) United States
(12) Patent Application Publication
(10) Pub. No.: US 2019/0174366 A1
(43) Pub. Date: Jun. 6, 2019

(54) METHODS, DEVICES AND NODES FOR RESUMING A RADIO CONNECTION FOR A WIRELESS DEVICE

(71) Applicant: TELEFONAKTIEBOLAGET LM ERICSSON (PUBL), Stockholm (SE)

(72) Inventors: Riikka SUSITAIVAL, HELSINKI (FI); Gunnar MILDH, SOLLENTUNA (SE); Stefan WAGER, ESPOO (FI)

(21) Appl. No.: 16/323,746

(22) PCT Filed: Aug. 9, 2017
(86) PCT No.: PCT/IB2017/054873

§ 371 Date: Feb. 6, 2019

Related U.S. Application Data
(60) Provisional application No. 62/374,694, filed on Aug. 12, 2016.

(51) Int. Cl. H04W 36/00; H04W 76/11; H04W 76/19; H04W 76/27

(52) U.S. Cl. CPC H04W 36/0033; H04W 76/27; H04W 76/19; H04W 76/11

(57) ABSTRACT

A method for resuming a radio connection for a wireless de-vice that is moving from a first cell with a first Radio Access technology (RAT) to a second cell with a second RAT, while being in an inactive state, is provided. The method comprises: receiving a resume identifier from a first network node in the first cell; sending, to a second network node in the second cell, a request to resume the radio connection, the request comprising the received resume identifier; and in response to sending the request, receiving a resume connection message from the second network node in the second cell. Also, a wireless device for carrying out this method is provided.

### CROSS-REFERENCE TO RELATED APPLICATIONS

This non-provisional patent application claims priority based upon the prior U.S. provisional patent application entitled “RRC RESUME BETWEEN LTE AND NR”, application No. 62/374,694, filed on Aug. 12, 2016 in the names of Gunnar Mildh, Stefan Wager and Riikka Susitaival.

### TECHNICAL FIELD

Certain embodiments of the present disclosure relate, in general, to wireless communications and, more particularly, to a radio resource control (RRC) resume operation between Long Term Evolution (LTE) and New Radio (NR).

### BACKGROUND

Third Generation Partnership Project (3GPP) Next Generation (NG) architecture specifications (see TR 23.799, Study on Architecture for Next Generation) and, more specifically, the Next Generation (NG) Access Technology (see TR 38.913, Study on Scenarios and Requirements for Next Generation Access Technologies) impact the design of Fifth Generation (5G) (see RP-160671, New SID Proposal: Study on New Radio Access Technology, DoCoMo) with respect to mobility and to the control plane design and mechanisms.

For example, NG architecture may impact Radio Resource Control (RRC) Resume operations, among others.

For Long Term Evolution (LTE), RRC connection suspend/resume is described in TS 36.300 as follows.
In the RRC Connection Release, the eNodeB (eNB) may request the User Equipment (UE) to retain the UE Access Stratum (AS) context including UE capability in RRC_IDLE. The eNB allocates Resume ID to the UE.
A RRC connection resume procedure is used at transition from RRC_IDLE to RRC_CONNECTED where previously stored information in the UE as well as in the eNB is utilized to resume the RRC connection.
In the message to resume, named RRC Connection Resume Request, the UE provides a Resume ID, establishment cause and short Message Authentication Code-Integrity (MAC-I) to the eNB. This information is to be used by the eNB to access the stored information required to resume the RRC connection.
The eNB resumes the connection with RRC Connection Resume message. This message includes Next hop Chaining Count (NCC) parameter as well as dedicated radio resource configuration.
At suspend-resume, security is continued and keys are refreshed. Short MAC-I is used as the authentication token at RRC resume procedure. Also the UE resets the COUNT.

During suspend of the connection, the UE stores the UE AS Context (or context information) including the current RRC configuration, the current security context, the Packet Data Convergence Protocol (PDCP) state including ROHC state, C-RNTI used in the source PCell, the cellIdentity, and the physical cell identity of the source PCell. During resume of the connection, the UE applies default configuration for Msg3 and Msg4. After that, the UE restores the stored RRC configuration from the stored AS context. The configuration received in the RRC Connection Resume message is a delta configuration as compared to the stored configuration (i.e., only the parameters received in the configuration message are modified and others are unmodified).

Also during resume, the UE re-establishes all Dedicated Radio Beares (DRBs) and Signaling Radio Bearers (SRBs). Some parameters, like CA configuration and DC configuration, are released.

NR includes a new dormant state, similar to RRC resume state in LTE. Mobility between NR and LTE in dormant state is desirable to reduce signaling load on the network. A particular problem that arises is that the conventional RRC Resume procedure does not support resume between NR and LTE. For example, a UE that moves from an LTE radio access technology (RAT) to a NR RAT while in RRC Idle state may not be able to resume its RRC connection in the NR RAT because the Resume procedure is incompatible.

### SUMMARY

Particular embodiments include user equipment (or wireless device) and network nodes for performing Radio Resource Control (RRC) Resume operations between Long Term Evolution (LTE) and New Radio (NR) radio access technologies (RATs). Particular embodiments include methods to resume RRC connection when moving between coverage area of LTE and NR in dormant state.

According to a first aspect, there is provided a method for resuming a radio connection for a wireless device that is moving from a first cell with a first Radio Access technology (RAT) to a second cell with a second RAT, while being in an inactive state. The method comprises: receiving a resume identifier from a first network node in the first cell; sending, to a second network node in the second cell, a request to resume the radio connection, the request comprising the received resume identifier; and in response to sending the request, receiving a resume connection message from the second network node in the second cell.

According to a second aspect, there is provided a wireless device for resuming a radio connection, when the wireless device is moving from a first cell comprising a first Radio Access Technology (RAT) to a second cell comprising a second RAT, while being in an inactivate state. The wireless device comprises a processing circuitry configured to cause the wireless device to: receive a resume identifier from a first network node in the first cell; send, to a second network node in the second cell, a request to resume the radio connection, the request comprising the received resume identifier; and in response to sending the request, receive a resume connection message from the second network node in the second cell.

According to a third aspect, there is provided a method, in a network node, for resuming a radio connection for a wireless device that is moving from a first cell comprising a first Radio Access Technology (RAT) to a second cell comprising a second RAT, while being in an inactivate state. The method comprises: receiving a request from the wireless device for resuming the radio connection, the request comprising a resume identifier; sending a request to a first network node in the first cell for context information of the wireless device, the request comprising the received resume identifier; and receiving the context information of the wireless device from the first network node.

According to a fourth aspect, there is provided a network node, for resuming a radio connection for a wireless device when the wireless device is moving from a first cell comprising a first Radio Access Technology (RAT) to a second cell comprising a second RAT, while being in an inactivate state. The network node comprises processing circuitry configured to cause the wireless device to: receive a request from the wireless device for resuming the radio connection, the request comprising a resume identifier; send a request to a first network node in the first cell for context information of the wireless device, the request comprising the received resume identifier; and receive the context information of the wireless device from the first network node.

According to a fifth aspect, there is provided a method for suspending a radio connection of a wireless device that is moving from a first cell comprising a first Radio Access Technology (RAT) to a second cell comprising a second RAT, while being in an inactivate state. The method comprises: sending a release message to the wireless device, the release message comprising a resume identifier; receiving a request for context information of the wireless device, from a network node in the second cell, the request comprising the resume identifier; and sending the context information of the wireless device to the network node of the second cell.

According to a sixth aspect, there is provided a network node for suspending a radio connection of a wireless device when the wireless device is moving from a first cell comprising a first Radio Access Technology (RAT) to a second cell comprising a second RAT, while being in an inactivate state. The network node comprises a processing circuitry configured to cause the network node to: send a release message to the wireless device, the release message comprising a resume identifier; receive a request for context information of the wireless device, from a network node in the second cell, the request comprising the resume identifier; and send the context information of the wireless device to the network node of the second cell.

Certain embodiments of the present disclosure may provide one or more technical advantages. As an example, certain embodiments minimize signaling when a wireless device moves between LTE and NR coverage areas by resuming the RAN context when the wireless device becomes active in the target system. Certain embodiments may have all, some, or none of these advantages. Other advantages will be apparent to persons of ordinary skill in the art.

### BRIEF DESCRIPTION OF THE DRAWINGS

For a more complete understanding of the embodiments and their features and advantages, reference is now made to the following description, taken in conjunction with the accompanying drawings, in which:

FIG. 1 is a block diagram illustrating an example wireless network, according to an embodiment;

FIG. 2 is a flow diagram of an example method in a wireless device, according to some embodiments;

FIG. 3 is a flow diagram of an example method in a first network node, according to some embodiments;

FIG. 4 is a flow diagram of an example method in a second network node, according to some embodiments;

FIG. 5A is a block diagram illustrating an example embodiment of a wireless device;

FIG. 5B is a block diagram illustrating example components of a wireless device;

FIG. 6A is a block diagram illustrating an example embodiment of a network node; and

FIG. 6B is a block diagram illustrating example components of a network node.

### DETAILED DESCRIPTION

Certain embodiments of the present disclosure facilitate performing Radio Resource Control (RRC) Resume operations between Long Term Evolution (LTE) and New Radio (NR) radio access technologies (RATs). Additional details of certain embodiments are further described in the example scenarios below.

In some embodiments, a non-limiting term “UE” is used. The UE herein can be any type of wireless device capable of communicating with a network node or another UE over radio signals. The UE may also be a radio communication device, target device, device to device (D2D) UE, machine type UE or UE capable of machine to machine communication (M2M), a sensor equipped with UE, iPAD, Tablet, mobile terminals, smart phone, laptop embedded equipped (LEE), laptop mounted equipment (LME), USB dongles, Customer Premises Equipment (CPE) etc.

Also in some embodiments, generic terminology “network node”, is used. It can be any kind of network node which may comprise of a radio network node such as base station, radio base station, base transceiver station, base station controller, network controller, gNB, NR BS, evolved Node B (eNB), Node B, Multi-cell/multicast Coordination Entity (MCE), relay node, access point, radio access point, Remote Radio Unit (RRU) Remote Radio Head (RRH), a multi-standard BS (a.k.a. MSR BS), a core network node (e.g., MME, SON node, a coordinating node, positioning node, MDT node, etc.), or even an external node (e.g., 3rd party node, a node external to the current network), etc. The network node may also comprise a test equipment.

The embodiments are applicable to single carrier as well as to multicarrier or carrier aggregation (CA) operation of the UE in which the UE is able to receive and/or transmit data to more than one serving cells. The term carrier aggregation (CA) is also called (e.g. interchangeably called) “multi-carrier system”, “multi-cell operation”, “multi-carrier operation”, “multi-carrier” transmission and/or reception. In CA one of the component carriers (CCs) is the primary component carrier (PCC) or simply primary carrier or even anchor carrier. The remaining ones are called secondary component carrier (SCC) or simply secondary carriers or even supplementary carriers. The serving cell is interchangeably called as primary cell (PCell) or primary serving cell (PSC). Similarly, the secondary serving cell is interchangeably called as secondary cell (SCell) or secondary serving cell (SSC).

The term “signaling” used herein may comprise any of: high-layer signaling (e.g., via RRC or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “time resource” used herein may correspond to any type of physical resource or radio resource expressed in terms of length of time. Examples of time resources are: symbol, time slot, subframe, radio frame, Transmission Time Interval (TTI), interleaving time, etc.

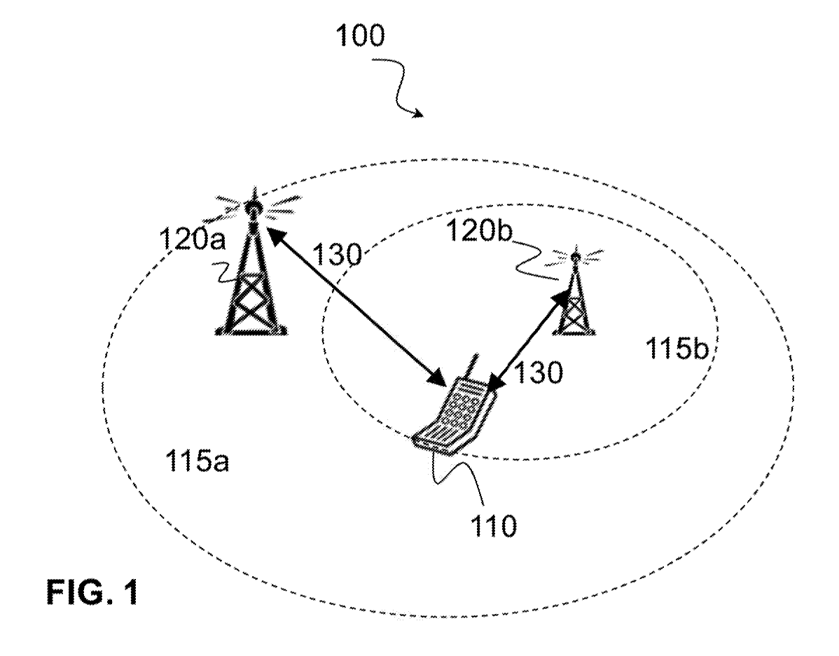

Particular embodiments are described with reference to FIGS. 1-6B of the drawings, like numerals being used for like and corresponding parts of the various drawings. LTE and NR are used throughout this disclosure as example cellular system, but the ideas presented herein may apply to other wireless communication systems as well.

FIG. 1 is a block diagram illustrating an example wireless network, according to a particular embodiment. Wireless network 100 includes one or more wireless devices 110 (such as mobile phones, smart phones, laptop computers, tablet computers, MTC devices, or any other devices that can provide wireless communication) and a plurality of network nodes 120 (e.g. 120a and 120b), such as base stations or eNodeBs. Network node 120 serves coverage area 115 (also referred to as cell 115). FIG. 1 illustrates two exemplary coverage areas 115a and 115b.

In general, wireless devices 110 that are within coverage of radio network node 120 (e.g., within cell 115b served by network node 120b) communicate with radio network node 120 by transmitting and receiving wireless signals 130. For example, wireless devices 110 and radio network node 120 may communicate wireless signals 130 containing voice traffic, data traffic, and/or control signals. A network node 120 communicating voice traffic, data traffic, and/or control signals to wireless device 110 may be referred to as a serving network node 120 for the wireless device 110.

In some embodiments, wireless device 110 may be referred to by the non-limiting term “UE.” Examples of UEs have been given above. Examples of a network node 120 have been given above as well.

Wireless signals 130 may include both downlink transmissions (from radio network node 120 to wireless devices 110) and uplink transmissions (from wireless devices 110 to radio network node 120).

Each network node 120 may have a single transmitter or multiple transmitters for transmitting wireless signals 130 to wireless devices 110. In some embodiments, network node 120 may comprise a multi-input multi-output (MIMO) system. Similarly, each wireless device 110 may have a single receiver or multiple receivers for receiving signals 130 from network nodes 120.

Network 100 may include carrier aggregation. For example, wireless device 110 may be served by both network node 120a and 120b and communicate wireless signals 130 with both network node 120a and 120b.

Wireless devices 110 may move between cells 115. For example, wireless device 110 may move between cell 115a and cell 115b. In particular embodiments, wireless device 110 may be in an RRC Idle state when wireless device 110 moves from cell 115a to cell 115b. Wireless device 110 may perform an RRC Resume in cell 115b.

In particular embodiments, cell 115a may comprise an LTE RAT and cell 115b may comprise a NR RAT. When wireless device 110 transitioned to RRC Idle in cell 115a, network node 120a may have sent wireless device 110 a resume Identity or identifier (ID). The resume ID is a unique identifier that identifies a UE in a suspended state. For example, the resume ID identifies the suspended UE context. When wireless device 110 performs an RRC Resume in cell 115b, wireless device provides the resume ID to network node 120b. In particular embodiments, network node 120b may request and receive context information for wireless device 110, based on the resume ID, from network node 120a.

In wireless network 100, each radio network node 120 may use any suitable radio access technology, such as long term evolution (LTE), LTE-Advanced, NR, UMTS, HSPA, GSM, cdma2000, WiMax, WiFi, and/or other suitable radio access technology. Wireless network 100 may include any suitable combination of one or more radio access technologies. For purposes of example, various embodiments may be described within the context of certain radio access technologies. However, the scope of the disclosure is not limited to the examples and other embodiments could use different radio access technologies.

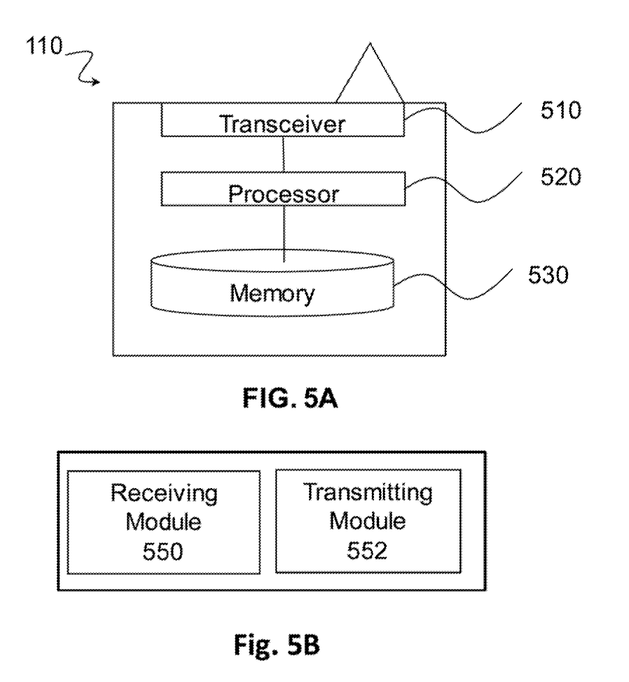

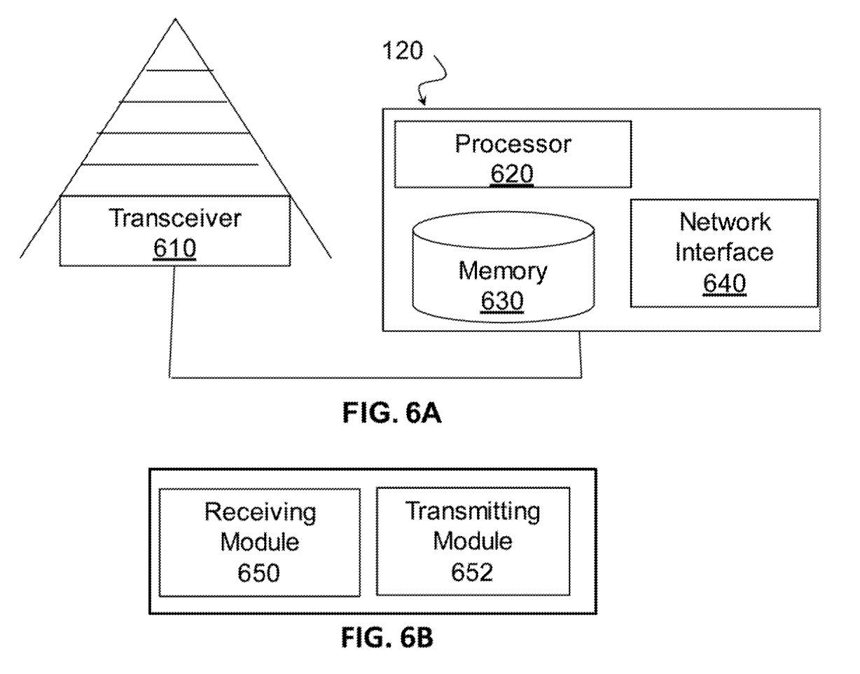

As described above, embodiments of a wireless network may include one or more wireless devices and one or more different types of radio network nodes capable of communicating with the wireless devices. The network may also include any additional elements suitable to support communication between wireless devices or between a wireless device and another communication device (such as a landline telephone). A wireless device may include any suitable combination of hardware and/or software. For example, in particular embodiments, a wireless device, such as wireless device 110, may include the components described below with respect to FIG. 5A. Similarly, a network node may include any suitable combination of hardware and/or software. For example, in particular embodiments, a network node, such as network node 120, may include the components described below with respect to FIG. 6A.

In particular embodiments, a first network node (e.g., serving eNB1) may suspend a radio connection to the wireless device (UE). Particular embodiments may use a special indication in the release message to the UE. For example, the release message may include an indication that the UE should move to a suspended state. Other embodiments may use a new message to inform the UE to move to the suspended state. The new message may contain the resume ID and other parameters (e.g. Next-Hop Chaining Counters) for example.

In the release message, eNB1 provides a Resume ID to the UE. In particular embodiments, Resume ID may comprise 40 bits. The Resume ID may comprise an eNB part of 20 bits and a UE part of 20 bits. In other words, the Resume ID can comprise a network node ID and a UE ID. Since the UE may move across several cells and between different eNBs while in the suspended state, the Resume ID should identify both the UE and the eNB that was last serving the UE. In other embodiments, the length of each part may differ. The serving eNB (e.g., eNB1) may provide key information, such as the Next-Hop Chaining Counters (NCC), for the UE. The UE may store its current context information when it is suspended.

The wireless device moves from a cell comprising a first RAT to a cell comprising a second RAT and performs reselection, ensuring that it is camping on the system with the best signal. For example, the UE may move from a NR cell to an LTE cell and perform reselection.

When uplink data arrives (or an uplink signaling message is triggered), the wireless device triggers resume of the RRC connection by sending a RRC Connection Resume Request to the new serving cell, which is controlled by a second network node (eNB2). In other embodiments, for network triggered activity, the UE is paged which triggers RRC Resume. In particular embodiments, the RRC Connection Resume Request message includes the Resume ID, short MAC-I, and establishment cause. If the UE has changed the RAT from LTE to NR or vice versa, the RRC Connection Resume Request may include an indication that the UE has changed RAT. The indication is used, for example, in case the resume ID is not unique across LTE and NR.

LTE specifications rely on the C-RNTI used in the source PCell, the cellldentity, and the physical cell identity of the source PCell to derive short MAC-I. In particular embodiments, if the second network node comprises an LTE RAT and the first network node comprises a NR RAT, then the parameters may be replaced by equivalent parameters in NR. In one embodiment, input for short-MAC-I calculation is based on RAT of source eNB (i.e., if the source eNB is LTE, LTE parameters are used and if the source eNB is NR, NR based parameters are used). This works in the scenario where the source eNB calculates the short-MAC-I.

The establishment cause depends on the type of uplink data triggering the initial access. Different establishment causes may exist in LTE and NR. Particular embodiments may include an establishment cause value of “other RAT” or “other” to inform the target network node that the wireless device is coming from another RAT.

In particular embodiments, the second network node (eNB2) may retrieve the context of the UE from the first network node (eNB1) over X2or X2* based on the Resume ID and/or on the indication of whether the UE changed RAT. A Context ID may be configured differently in LTE and NR, in which case the network may need to know the source RAT to extract the eNB part of the Context ID.

The eNB1 may provide the UE Context of the UE to eNB2. The context may include information received from the core network (CN) such as the following.
UE security context, e.g. KeNB, NH, NHCC, UE security capabilities
QoS information about flows/bearers
Tunnel information, etc.
CN/RAN interface identifiers (S1 MME UE id, S1 eNB UE id)
Mobility restriction information
UE radio access capabilities
Subscriber profile

The first network node may also include information about the wireless devices RRC configuration in the source RAT. For example, eNB1 may provide information such as PDCP configuration, mobility configuration, RLC/MAC/PHY configuration, and UE received system information. In addition, the first network node may transmit any packets waiting for the wireless device in the source RAN, as well as information about PDCP, GTP, or any other packet related sequence numbers.

In particular embodiments, the first network node calculates short-MAC-I and thus verifies the correct wireless device. The second network node may inform the first network node of the short-MAC-I received from the wireless device when requesting the context. Based on the context received from the first network node, the second network node may derive which data bearers can be re-established. The second network node may be informed over X2 to which RAT the wireless device context is based on. The stored configuration may also include an indication of the ASN.1 and/or release version associated with the stored configuration.

In particular embodiments, eNB2 uses received UE context and old RRC configuration to derive a new RRC configuration to be transmitted for the UE. To configure DRBs, QoS configuration and existing PDCP/RLC/logical channel configurations can be reused even if the RRC configuration transmitted corresponds to another RAT. In another embodiment, the RRC configuration of lower layers may not be reused and eNB2 will send new configuration of at least PHY, MAC, and RLC layers. Which layers that need new configuration will depend on the differences between the protocols in the two RATs. For example, the PDCP configuration may be retained even when UE is changing RAT. The eNB2 may use received QoS information when making the configurations of the lower layers.

If the wireless device detects that it has sent an RRC Connection Resume Request to a different RAT, then the wireless device may discard stored PHY, MAC, and RLC configurations. As a note, the UE can detect that the RAT is different when detecting a cell in which the UE sends the resume request, for example. Reference signals in LTE and NR are different.

If the PDCP configuration is compliant between RATs, it can be kept but otherwise may also be discarded. The wireless device may be informed by the network if PDCP configuration is discarded. In some embodiments, the second network node may inform the wireless device if any part of the RRC configuration and UE context may be stored and if any part may be discarded. If configured, the wireless device may store ROHC context. This step may occur earlier or later in the procedure.

In particular embodiments, the second network node sends a RRC Connection Resume message to the wireless device. The RRC Connection Resume message may provide new PHY, MAC, and bearer configuration. Bearer configuration may include RLC and PDCP configuration. This message may also include NCC (if not provided in the suspend message) and a new security algorithm.

In some embodiments, the wireless device derives new security keys based on the old keys or other stored security information. The wireless device applies the new radio configuration and also establishes/re-establishes data and signaling bearers. The wireless device may send RRC Connection Resume Complete message to the second network node.

In some embodiments, the network node may control if the wireless device is allowed to resume connection to other RAT. Control may be given from the source network node in the message that suspends the connection to the wireless device. Alternatively, the target network node may broadcast control information if the RRC Resume is allowed from a different RAT.

In some embodiments, if the second network node is not able to fetch the RAN context belonging to the different RAT, then the second network node may respond to the wireless device using a normal RRC connection setup message, indicating the old RAN context is discarded. In this case, the wireless device will perform a normal connection setup as if it was connecting from IDLE without a RAN context. The normal connection setup will trigger the Core Network (CN) to re-build the wireless device's RAN context in the RAN.

Particular embodiments support RAN paging across different RAT (i.e., if the UE connection in the source RAT has been suspended and the UE has moved over to the target RAT, but is still within an area for which it is registered in, the source RAN node can initiate paging both in its own coverage area and in the other RAT coverage area. The paging may be transferred over an inter-RAN interface between the source and target RAT. When the UE receives the paging, it may initiate a similar procedure to the procedure described above (in which the UE triggers the resume request when uplink data arrives), with the difference that the procedure is initiated to receive data not to send data.

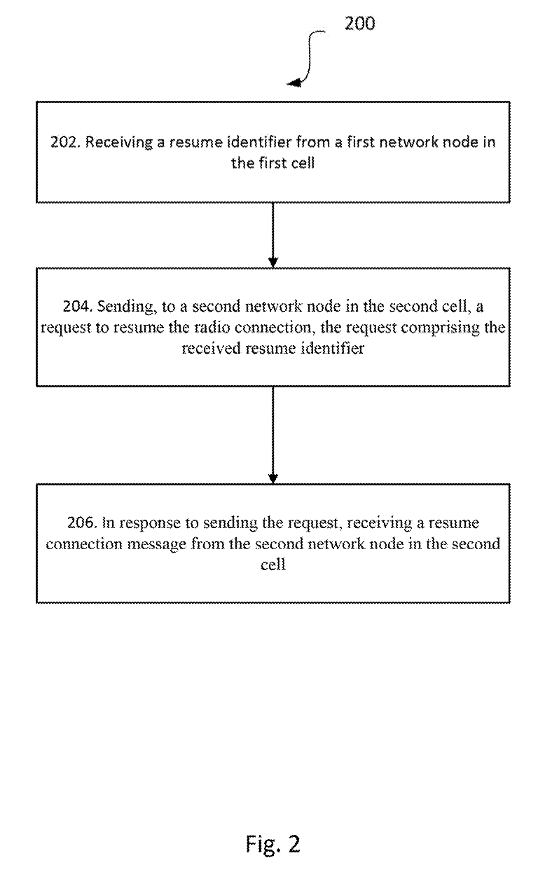

FIG. 2 is a flow diagram of an example method 200 in a wireless device, according to some embodiments, for resuming a radio connection for the wireless device which is moving from a first cell comprising a first RAT to a second cell comprising a second RAT, while being in an inactive state. In some embodiments, one or more steps of method 200 may be performed by components of wireless network 100 described with reference to FIG. 1. The first cell may be 115a and the second cell may be 115b. The radio connection may be a RRC connection.

The method begins at step 202, where the wireless device receives a resume identifier from a first network node in the first cell. For example, wireless device 110 may receive a resume identifier from network node 120a. The resume identifier may comprise any of the information described above, e.g. the resume identifier may comprise an identifier of the first network node in the first cell and an identifier of the wireless device.

At step 204, the wireless device sends a request to a second network node in the second cell, for resuming the radio connection. This request can be referred to as the “resume request”. For example, the wireless device 110 may send a resume request to network node 120b. The resume request may include the resume identifier. In some embodiments, the resume request may include the short MAC-I, establishment cause, and/or change of RAT indication, as described above.

At step 206, the wireless device receives a resume connection message from the second network node in the second cell in response to sending the request. For example, wireless device 110 may receive a resume connection message from network node 120b. The resume connection message may include a new radio configuration, such as a new PHY, MAC, and bearer configuration for wireless device 110. The resume connection message may include new security information for wireless device 110. The new radio configuration may be determined based on the context information of the wireless device received from the first network node.

In some embodiments, the resume identifier is used by the second network node to request context information of the wireless device from the first network node.

In some embodiments, sending the request is triggered when uplink data arrive at the wireless device.

In some embodiments, sending the request is triggered when the wireless device is paged. In some embodiments, the request comprises a short Message Authentication Code -Integrity (MAC-I) and an establishment cause.

In some embodiments, the wireless device stores the current context information of the wireless device.

In some embodiments, the wireless device further receives an indication for retaining some parameters related to the first RAT.

In some embodiments, in response to detecting that the second RAT is different from the first RAT, the wireless device discards the stored physical layer (PHY), Media Access Control (MAC) and Radio Link Control (RLC) configurations.

In some embodiments, the wireless device receives a message from the second network node to inform the wireless device if any part of a current radio configuration and context information of the wireless device may be stored and if any part may be discarded.

In some embodiments, the new radio configuration comprises a PHY, MAC and bearer configuration.

In some embodiments, the wireless device applies the new radio configuration and establishes data and signaling bearers.

Modifications, additions, or omissions may be made to method 200 illustrated in FIG. 2. Additionally, one or more steps in method 200 may be performed in parallel or in any suitable order.

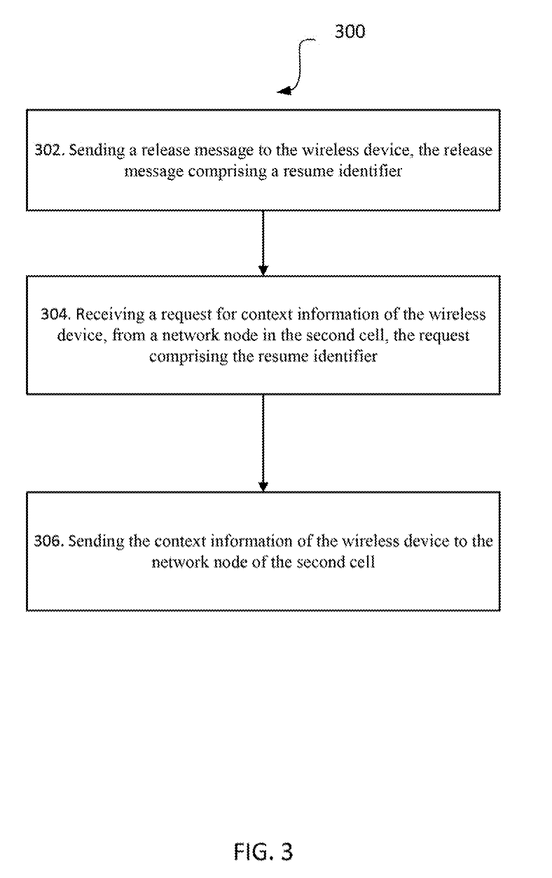

FIG. 3 is a flow diagram of an example method 300 in a first network node of a first cell, according to some embodiments, for suspending a radio connection of a wireless device that is moving from the first cell comprising a first Radio Access Technology (RAT) to a second cell comprising a second RAT, while being in an inactivate state. In particular embodiments, one or more steps of method 300 may be performed by components of wireless network 100 described with reference to FIG. 1. The radio connection may be a RRC connection.

The method begins at step 302, where the first network node sends a release message to a wireless device, the release message comprising a resume identifier. For example, network node 120a is the first network node and may send a release message to wireless device 110 comprising a resume identifier according to any of the resume identifiers described above. For example, the resume identifier may comprise an identifier of the network node in the first cell and an identifier of the wireless device.

At step 304, the first network node receives a request for context information of the wireless device from a second network node in the second cell. The second network node may be 120b. For example, wireless device may have moved into coverage of the network node 120b. Wireless device 110 may have sent a resume request to network node 120b. Network node 120b determines that wireless device was previously connected to network node 120a, which comprises a different RAT. Then, the network node 120b sends a request to network node 120a for the context information of the wireless device. The request may include the resume ID sent to wireless device 110 at step 302. In particular embodiments, the resume request may be sent over X2.

At step 306, the first network node transmits the context information for the wireless device to the second network node. For example, network node 120a looks up context information for wireless device 110 based on the resume identifier and transmits the context information to network node 120b. The context information may include any of the context information described above. In particular embodiments, one or both of the first and second network nodes may re-format the context information based on source or destination RAT type.

In some embodiments, the first network node may also send a configuration of the radio connection to the network node in the second cell.

In some embodiments, the first network may calculate a Message Authentication Code-Integrity (MAC-I) to verify an identity of the wireless device.

Modifications, additions, or omissions may be made to method 300 illustrated in FIG. 3. Additionally, one or more steps in method 300 may be performed in parallel or in any suitable order.

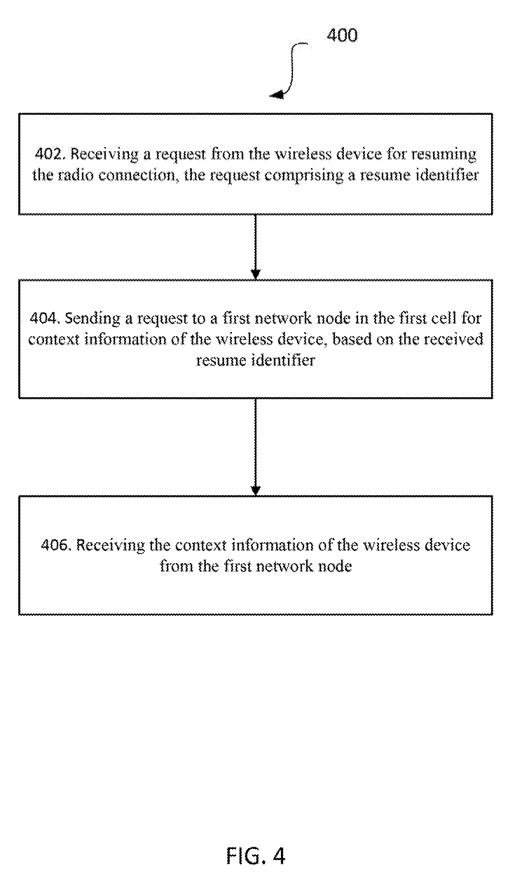

FIG. 4 is a flow diagram of an example method 400 in a second network node, according to some embodiments, for resuming a radio connection for a wireless device that is moving from a first cell comprising a first Radio Access Technology (RAT) to a second cell comprising a second RAT, while being in an inactivate state. In particular embodiments, one or more steps of method 400 may be performed by components of wireless network 100 described with reference to FIG. 1. The first cell may be 115a and the second cell may be 115b. The radio connection may be a RRC connection.

The method begins at step 402, where the second network node in the second cell receives a request for resuming the radio connection from the wireless device. This request may be referred to as a resume request. For example, network node 120b may receive a resume request from wireless device 110. In particular embodiments, the resume request comprises a resume identifier associated with wireless device 110. The resume request and resume identifier may comprise any of the elements described above.

At step 404, the second network node sends a request message to a first network node. For example, network node 120b determines that the received resume request includes a resume identifier that refers to a UE context stored at network node 120a. Network node 120b sends a request for UE context to network node 120a, the request comprising the resume identifier.

At step 406, the second network node receives the context information from the first network node. For example, network node 120a retrieves UE context information for wireless device 110 based on the resume identifier and sends the context information to network node 120b.

In some embodiments, the second network node may determine a new radio configuration for resuming the radio connection, based on the received context information.

In some embodiments, the second network node may send the new radio configuration to the wireless device, in response to the resume request.

In some embodiments, the context information of the wireless device comprises a security context, Quality of Service (QoS) information of bearers, tunneling information, core network and radio access technology interface identifiers, mobility restriction information, radio access capabilities of the wireless device, and subscriber profile.

In some embodiments, the second network node may inform the wireless device if any part of the radio configuration and UE context may be stored and if any part may be discarded.

In some embodiments, the resume request may comprise an indication that the wireless device has changed RAT, when moving from the first cell to the second cell.

In some embodiments, the resume request may comprise a short Message Authentication Code -Integrity (MAC-I) and an establishment cause.

In some embodiments, the second network node may send the received short MAC-I to the first network node.

Modifications, additions, or omissions may be made to method 400 illustrated in FIG. 4. Additionally, one or more steps in method 400 may be performed in parallel or in any suitable order.

FIG. 5A is a block diagram illustrating an example embodiment of a wireless device. The wireless device is an example of the wireless devices 110 illustrated in FIG. 1. Particular examples include a mobile phone, a smart phone, a PDA (Personal Digital Assistant), a portable computer (e.g., laptop, tablet), a sensor, a modem, a machine type (MTC) device/machine to machine (M2M) device, laptop embedded equipment (LEE), laptop mounted equipment (LME), USB dongles, a device-to-device capable device, a NB-IoT device, or any other device that can provide wireless communication. The wireless device includes transceiver 510, processor 520, and memory 530. The processor 520 and the memory 530 can be collectively referred to as a processing circuitry. In some embodiments, transceiver 510 facilitates transmitting wireless signals to and receiving wireless signals from wireless network node 120 (e.g., via an antenna), processor 520 executes instructions to provide some or all of the functionality described herein as provided by the wireless device, and memory 530 stores the instructions executed by processor 520.

Processor 520 includes any suitable combination of hardware and software implemented in one or more integrated circuits or modules to execute instructions and manipulate data to perform some or all of the described functions of the wireless device. In some embodiments, processor 520 may include, for example, one or more computers, one more programmable logic devices, one or more central processing units (CPUs), one or more microprocessors, one or more applications, and/or other logic, and/or any suitable combination of the preceding. Processor 520 may include analog and/or digital circuitry configured to perform some or all of the described functions of wireless device 110. For example, processor 520 may include resistors, capacitors, inductors, transistors, diodes, and/or any other suitable circuit components.

Memory 530 is generally operable to store computer executable code and data. Examples of memory 530 include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or or any other volatile or non-volatile, non-transitory computer-readable and/or computer-executable memory devices that store information.

The processing circuitry performs the operations related to method 200. For example, processor 520 in communication with transceiver 510 communicates resume requests and resume identifiers with network node 120. Other embodiments of the wireless device may include additional components (beyond those shown in FIG. 5A) responsible for providing certain aspects of the wireless device's functionality, including any of the functionality described above and/or any additional functionality (including any functionality necessary to support the solution described above).

FIG. 5B is a block diagram illustrating example components of a wireless device 110, according to another embodiment. The components may include receiving module 550 and transmitting/sending module 552.

Receiving module 550 may perform the receiving functions of wireless device 110. For example, receiving module 550 may perform the receiving steps (e.g., steps 202 and 206 of method 200) described with respect to FIG. 2. In certain embodiments, receiving module 550 may include or be included in processor 520. In particular embodiments, receiving module 550 may communicate with transmitting/sending module 552.

Transmitting/sending module 552 may perform the transmitting functions of wireless device 110. For example, transmitting/sending module 552 may provide the sending steps (e.g., step 204) described with respect to FIG. 2. In certain embodiments, transmitting/sending module 552 may include or be included in processor 520. In some embodiments, transmitting/sending module 552 may communicate with receiving module 550.

FIG. 6A is a block diagram illustrating an example embodiment of a network node. Network node 120 can be an eNodeB, a nodeB, a gNB, a base station, a wireless access point (e.g., a Wi-Fi access point), a low power node, a base transceiver station (BTS), a transmission point or node, a remote RF unit (RRU), a remote radio head (RRH), or other radio access node. Network node 120 includes at least one transceiver 610, at least one processor 620, at least one memory 630, and at least one network interface 640. Transceiver 610 facilitates transmitting wireless signals to and receiving wireless signals from a wireless device, such as wireless devices 110 (e.g., via an antenna); processor 620 executes instructions to provide some or all of the functionality described above as being provided by a network node 120; memory 630 stores the instructions executed by processor 620; and network interface 640 communicates signals to backend network components, such as a gateway, switch, router, Internet, Public Switched Telephone Network (PSTN), controller, and/or other network nodes 120. Processor 620 and memory 630 can be of the same types as described with respect to processor 520 and memory 530 of FIG. 5A above. The processor 620 and the memory 630 can be collectively referred to as a processing circuitry.

In some embodiments, network interface 640 is communicatively coupled to processor 620 and refers to any suitable device operable to receive input for network node 120, send output from network node 120, perform suitable processing of the input or output or both, communicate to other devices, or any combination of the preceding. Network interface 640 includes appropriate hardware (e.g., port, modem, network interface card, etc.) and software, including protocol conversion and data processing capabilities, to communicate through a network.

A first network node (e.g. 120a) may have processing circuitry comprising processor 620 and memory 630, which can perform the operations of method 300. A second network node (e.g. 120b) may have processing circuitry comprising processor 620 and memory 630, which can perform the operations of method 400. In particular embodiments, processor 620 in communication with transceiver 610 may exchange resume identifiers and context information with other network nodes 120 or wireless devices 110.

Other embodiments of network node 120 include additional components (beyond those shown in FIG. 6A) responsible for providing certain aspects of the network node's functionality, including any of the functionality described above and/or any additional functionality (including any functionality necessary to support the solution described above). The various different types of radio network nodes may include components having the same physical hardware but configured (e.g., via programming) to support different radio access technologies, or may represent partly or entirely different physical components.

FIG. 6B is a block diagram illustrating example components of a network node 120. The components may include receiving module 650 and transmitting/sending module 652.

Receiving module 650 may perform the receiving functions of network node 120. For example, receiving module 650 may perform the receiving steps (e.g., steps 304 of method 300, and 402 and 406 of method 400) described with respect to FIGS. 3 and 4. In certain embodiments, receiving module 650 may include or be included in processor 620. In particular embodiments, receiving module 650 may communicate with transmitting module 652.

Transmitting/sending module 652 may perform the transmitting functions of network node 120. For example, transmitting module 652 may provide the transmitting steps (e.g., steps 302, 306 of method 300 and 404 of method 400) described with respect to FIGS. 3 and 4. In certain embodiments, transmitting/sending module 652 may include or be included in processor 620. In particular embodiments, transmitting/sending module 652 may communicate with receiving module 650.

Some embodiments of the disclosure may provide one or more technical advantages. Some embodiments may benefit from some, none, or all of these advantages. Other technical advantages may be readily ascertained by one of ordinary skill in the art. Certain embodiments minimize signaling when a wireless device moves between LTE and NR coverage areas by resuming the RAN context when the wireless device becomes active in the target system.

Although this disclosure has been described in terms of certain embodiments, alterations and permutations of the embodiments will be apparent to those skilled in the art. Although some embodiments have been described with reference to certain radio access technologies, any suitable radio access technology (RAT) or combination of radio access technologies may be used, such as long term evolution (LTE), LTE-Advanced, NR, UMTS, HSPA, GSM, cdma2000,WiMax, WiFi, etc. Accordingly, the above description of the embodiments does not constrain this disclosure. Other changes, substitutions, and alterations are possible without departing from the spirit and scope of this disclosure.

### Abbreviations

3GPP 3rd Generation Partnership Project
CA Carrier Aggregation
CC Component Carrier
CN Core Network
CP Control Plane
C-RNTI Cell Radio Network Temporary Identifier
DC Domain Controller
eNB Evolved Node B
eNodeB Evolved Node B
FDD Frequency Division Duplex
gNB NR base station
GPRS General Packet Radio Service
GTP GPRS Tunneling Protocol
GSM Global System for Mobile Communications
HSPA High Speed Packet Access
LTE Long-Term Evolution
MAC Medium Access Control
MME Mobility Management Entity
NR New Radio
PCC Primary Component Carrier
PCell Primary Cell
PDCP Packet Data Convergence Protocol
PDU Protocol Data Unit
PHY Physical Layer
QoS Quality of Service
RAT Radio Access Technology
ROHC RObust Header Compression
RLC Radio Link Control
RRC Radio Resource Control
SCC Secondary Component Carrier
SCell Secondary Cell
SON Self Organized Network
TDD Time Division Duplex
UE User Equipment
UMTS Universal Mobile Telecommunications System

1. A method for resuming a radio connection for a wireless device that is moving from a first cell with a first Radio Access technology (RAT) to a second cell with a second RAT, while being in an inactive state, the method comprising:
receiving a resume identifier from a first network node in the first cell;
sending, to a second network node in the second cell, a request to resume the radio connection, the request comprising the received resume identifier; and
in response to sending the request, receiving a resume connection message from the second network node in the second cell;
wherein the method further comprising, in response to detecting that the second RAT is different from the first RAT, discarding one or more stored physical layer (PHY), Media Access Control (MAC) and Radio Link Control (RLC) configurations.

2. The method of claim 1, wherein the resume identifier is used by the second network node to request context information of the wireless device from the first network node.

3. The method of claim 2, wherein the resume connection message comprises a new radio connection configuration determined based on the context information.

4. (canceled).

5. (canceled).

6. (canceled).

7. The method of claim 1, wherein the request further comprises an indication that the wireless device has changed RAT, when moving from the first cell to the second cell.

8. (canceled).

9. The method of claim 1, further comprising receiving an indication for retaining some parameters related to the first RAT.

10. (canceled).

11. (canceled).

12. The method of claim 3, wherein the new radio configuration comprises a PHY, MAC and bearer configuration.

13. The method of claim 3, further comprising applying the new radio configuration and establishing data and signaling bearers.

14. A wireless device for resuming a radio connection, when the wireless device is moving from a first cell comprising a first Radio Access Technology (RAT) to a second cell comprising a second RAT, while being in an inactivate state, the wireless device comprising a processing circuitry including a processor, and a memory connected to the processor, the memory containing instructions that, when executed, cause the processor to:
receive a resume identifier from a first network node in the first cell;
send, to a second network node in the second cell, a request to resume the radio connection, the request comprising the received resume identifier; and
in response to sending the request, receive a resume connection message from the second network node in the second cell;
in response to detecting that the second RAT is different from the first RAT, discard stored physical layer (PHY), Media Access Control (MAC) and Radio Link Control (RLC) configurations.

15. (canceled).

16. The wireless device of claim 14, wherein the resume identifier is used by the second network node to request context information of the wireless device from the first network node.

17. The wireless device of claim 16, wherein the resume connection message comprises a new radio connection configuration determined based on the context information.

18. (canceled).

19. (canceled).

20. The wireless device of claim 14, wherein the request comprises a short Message Authentication Code -Integrity (MAC-I) and an establishment cause.

21. The wireless device of claim 14, wherein the request further comprises an indication that the wireless device has changed RAT, when moving from the first cell to the second cell.

22. (canceled) .

23. The wireless device of claim 14, wherein the processor is configured to receive an indication for retaining some parameters related to the first RAT.

24. The wireless device of claim 14, wherein the processor is configured to, in response to detecting that the second RAT is different from the first RAT, discard stored physical layer (PHY), Media Access Control (MAC) and Radio Link Control (RLC) configurations.

25. The wireless device of claim 14, wherein the processor is configured to receive a message from the second network node to inform the wireless device if any part of a current radio configuration and context information of the wireless device may be stored and if any part may be discarded.

26. The wireless device of claim 17, wherein the new radio configuration comprises a PHY, MAC and bearer configuration.

27. The wireless device of claim 26, wherein the processor is configured to apply the new radio configuration and establish data and signaling bearers.

28. (canceled).

29. (canceled).

30. (canceled).

31. (canceled).

32. (canceled).

33. (canceled).

34. (canceled).

35. (canceled).

36. A network node, for resuming a radio connection for a wireless device when the wireless device is moving from a first cell comprising a first Radio Access Technology (RAT) to a second cell comprising a second RAT, while being in an inactivate state, the network node comprising processing circuitry configured to:
receive a request from the wireless device for resuming the radio connection, the request comprising a resume identifier;
send a request to a first network node in the first cell for context information of the wireless device, the request comprising the received resume identifier;
inform the wireless device if any part of a radio configuration and context information of the wireless device is to be stored and if any part is to be discarded; and
receive the context information of the wireless device from the first network node.

37. (canceled).

38. (canceled).

39. (canceled).

40. (canceled).

41. (canceled).

42. (canceled).

43. (canceled).

44. (canceled).

45-57. (canceled).

58. The wireless device of claim 14, wherein the processor is configured to receive control information from one of the first network node in a message that suspends the connection to the wireless and the second network node in a broadcast signal, wherein the control information includes information to allow or not resuming the radio connection.

59. The wireless device of claim 14, wherein the processor is configured to keep a Packet Data Convergence Protocol (PDCP) configuration.
